(19) United States
(12) Patent Application Publication
(10) Pub. No.: US 2018/0172807 A1
(43) Pub. Date: Jun. 21, 2018

(54) Method of Providing Enhanced Range Accuracy

(71) Applicant: Analog Devices Global, Hamilton (BM)

(72) Inventors: Levent Korkut, Istanbul (TR); Sinan Alemdar, Istanbul (TR)

(21) Appl. No.: 15/385,450

(22) Filed: Dec. 20, 2016

(51) Int. Cl. G01S 7/486; G01S 17/10; G01S 7/484

(52) U.S. Cl. CPC G01S 7/4865; G01S 7/484; G01S 17/10

(57) ABSTRACT

A system and method can be provided for introducing a varying time delay between a sequence of electrical pulses in a laser range finding system. A laser beam can be modulated with the sequence of electrical pulses. The laser beam can be transmitted towards a target and a photosensitive element can receive the modulated laser beam after reflection by the target. Control circuitry can determine a distance between the laser range finding system and the target based on the varying time delay, such as to provide a reduced error in the distance determination.

### FIELD OF THE DISCLOSURE

The present disclosure relates to systems and methods for improving a range accuracy in a laser range finding system.

### BACKGROUND

Certain laser range finding systems can be based on a time-of-flight measurement, where an absolute time between a transmitted signal and a received signal can be measured. A sampling interface, such as an analog-to-digital converter or a comparator can convert an electrical pulse on a receiver side of the laser range finding system into a digital output. A range resolution and accuracy can be limited by the frequency of a reference clock and performance of the sampling interface.

### SUMMARY OF THE DISCLOSURE

In certain systems, a laser range finding system can include an analog-to-digital converter. The analog-to-digital converter can convert an electrical pulse, such as that received from a photosensitive element and an amplifier into a digital output. During the conversion process, such as due to a finite sampling rate of the analog-to-digital converter, an error can be introduced in the time stamp of the digital output. In laser ranging systems, an error in the time stamp of the digital output can lead to errors in a distance determined by the laser range finding system. The inventors have recognized, among other things, that it is possible to provide an improved time resolution of a digital output, such as by modulating a laser beam with a burst of pulses and then subsequently overlapping each received pulse in the burst of pulses, such as to provide reduced time stamp errors in the laser range finding system, while keeping the sampling interface simple and slow (e.g., without increasing a sampling rate of the analog-to-digital converter). Further features of the disclosure are provided in the appended claims, which features may optionally be combined with each other in any permutation or combination, unless expressly indicated otherwise elsewhere in this document.

In an aspect, the disclosure can feature a method for determining a target distance in a laser range finding system. The method can include generating a sequence of electrical pulses. The method can also include adjusting the generated sequence of electrical pulses, such as to introduce a varying time delay between the pulses in the generated sequence of electrical pulses. The method can also include modulating a laser beam with the adjusted sequence of electrical pulses, such as to form a modulated laser beam. The method can also include transmitting the modulated laser beam towards a target. The method can also include receiving at least a portion of the transmitted laser beam. The method can also include converting the received portion of the transmitted laser beam into a received sequence of electrical pulses. The method can also include determining a time elapsed between transmitting the modulated laser beam towards the target and receiving at least a portion of the transmitted laser beam, where the elapsed time can be determined based at least in part on the varying time delay between the pulses in the generated sequence of electrical pulses. The generated sequence of electrical pulses can include periodic bursts of electrical pulses, and adjusting the generated sequence of electrical pulses can include introducing a varying time delay between electrical pulses within the periodic bursts. The method can also include determining a time elapsed between transmitting the modulated laser beam towards the target and receiving at least a portion of the transmitted laser beam, such as based on an alignment of an electrical pulse in the received electrical sequence of pulses with a reference sampling clock. Adjusting the generated sequence of electrical pulses can include modulating a time delay circuit, such as to introduce a varying time delay between electrical pulses within the periodic bursts. Adjusting the generated sequence of electrical pulses can include modulating a reference sampling clock of a digital-to-analog converter, such as to introduce a varying time delay between electrical pulses within the periodic bursts. Adjusting the generated sequence of electrical pulses can include modulating a pulse width of electrical pulses within the periodic bursts, such as to provide a varying time delay.

In an aspect, the disclosure can feature a method for determining a target distance in a laser range finding system. The method can include generating a sequence of electrical pulses. The method can also include modulating a laser beam with the generated sequence of electrical pulses, such as to form a modulated laser beam. The method can also include transmitting the modulated laser beam towards a target. The method can also include receiving at least a portion of the transmitted laser beam. The method can also include converting the received portion of the transmitted laser beam into a received sequence of electrical pulses. The method can also include adjusting the received sequence of electrical pulses, such as to introduce a varying time delay between pulses in the received sequence of electrical pulses. The method can also include determining a time elapsed between transmitting the modulated laser beam towards the target and receiving at least a portion of the transmitted laser beam, where the elapsed time can be determined based at least in part on the varying time delay between the pulses in the received sequence of electrical pulses. The received sequence of electrical pulses can include periodic bursts of electrical pulses, and adjusting the received sequence of electrical pulses can include introducing a varying time delay between electrical pulses within the periodic bursts. The method can also include determining a time elapsed between transmitting the modulated laser beam towards the target and receiving at least a portion of the transmitted laser beam, such as based on alignment of an electrical pulse in the received sequence of electrical pulses with a reference sampling clock. Adjusting the received sequence of electrical pulses can include modulating a time delay circuit, such as to introduce a varying time delay between electrical pulses within the periodic bursts. Adjusting the received sequence of electrical pulses can include modulating a reference sampling clock of an analog-to-digital converter, such as to introduce a varying time delay between electrical pulses within the periodic bursts.

In an aspect, the disclosure can feature a laser range finding system for determining a target distance. The laser range finding system can include a digital-to-analog converter configured to generate a sequence of electrical pulses. The laser range finding system can also include modulation circuitry configured to provide a varying time delay between the pulses in the generated sequence of pulses. The laser range finding system can also include a laser driver configured to modulate a laser beam with the modulated sequence of electrical pulses to form a modulated laser beam. The laser range finding system can also include a laser configured to transmit the modulated laser beam towards a target. The laser range finding system can also include a photosensitive element configured to receive at least a portion of the transmitted laser beam. The laser range finding system can also include an amplifier configured to convert the received portion of the transmitted laser beam into a received electrical signal. The laser range finding system can also include processing circuitry configured to determine a time elapsed between transmitting the modulated laser beam towards the target and receiving at least a portion of the transmitted laser beam, where the elapsed time can be determined based at least in part on the varying time delay between the pulses in the generated sequence of electrical pulses. The sequence of electrical pulses can include periodic bursts of electrical pulses, and providing a varying time delay can include introducing a varying time delay between electrical pulses within the periodic bursts. The processing circuitry can be further configured to determine a time elapsed between transmitting the modulated laser beam towards the target and receiving at least a portion of the transmitted laser beam, such as based on alignment of an electrical pulse in the received electrical signal with a reference sampling clock. The laser range finding system can also include a time delay circuit configured to modulate the sequence of electrical pulses, such as to introduce a varying time delay between the pulses in the generated sequence of electrical pulses. The laser range finding system can also include a clock modulation circuit configured to modulate a reference sampling clock of the digital-to-analog converter, such as to introduce a varying time delay between the pulses in the generated sequence of electrical pulses. The laser range finding system can also include an analog-to-digital converter configured to sample and digitize the received electrical signal, wherein the analog-to-digital converter can have a lower sampling rate than the digital-to-analog converter. The varying time delay between electrical pulses within the periodic bursts can be less than or equal to a period of a reference sampling clock of the analog-to-digital converter. The processing circuitry can be further configured to overlap each electrical pulse within a periodic burst, such as to provide an effective sampling rate that is larger than the sampling rate of the analog-to-digital converter.

In an aspect, the disclosure can feature a laser range finding system for determining a target distance. The laser range finding system can include a digital-to-analog converter configured to generate a sequence of electrical pulses. The laser range finding system can also include a laser driver configured to modulate a laser beam with the modulated sequence of electrical pulses to form a modulated laser beam. The laser range finding system can also include a laser configured to transmit the modulated laser beam towards a target. The laser range finding system can also include a photosensitive element configured to receive at least a portion of the transmitted laser beam. The laser range finding system can also include an amplifier configured to convert the received portion of the transmitted laser beam into a received sequence of electrical pulses. The laser range finding system can also include modulation circuitry configured to provide a varying time delay between the pulses in the received sequence of electrical pulses. The laser range finding system can also include processing circuitry configured to determine a time elapsed between transmitting the modulated laser beam towards the target and receiving at least a portion of the transmitted laser beam, the elapsed time being determined based at least in part on the varying time delay between the pulses in the received sequence of electrical pulses.

### BRIEF DESCRIPTION OF THE DRAWINGS

The present disclosure will now be described, by way of example, with reference to the accompanying drawings, in which:

FIG. 1A illustrates a diagram of a laser range finding system.

FIG. 1B illustrates a diagram of an analog electrical pulse being sampled by an analog-to-digital converter.

FIG. 1C illustrates a diagram of an analog electrical pulse being sampled by an analog-to-digital converter.

FIG. 1D illustrates a diagram of an analog electrical pulse being sampled by an analog-to-digital converter.

FIG. 2A illustrates a diagram of a laser range finding system.

FIG. 2B illustrates an example of a sequence of analog pulses.

FIG. 2C illustrates an example of a sequence of delayed periodic analog pulses.

FIG. 2D illustrates an example of the received sequence of electrical pulses being converted into a digital signal.

FIG. 2E an example of overlaying digitized pulses.

FIG. 2F illustrates a diagram of a laser range finding system.

FIG. 3 illustrates a method of operation of a laser range finding system.

FIG. 4 illustrates a method of operation of a laser range finding system.

### DETAILED DESCRIPTION OF EMBODIMENTS OF THE DISCLOSURE

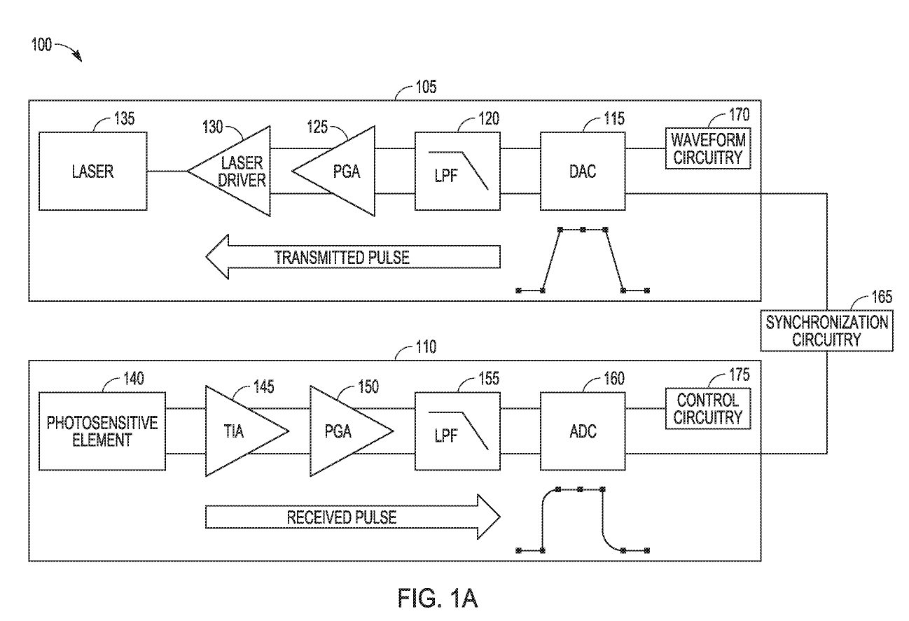

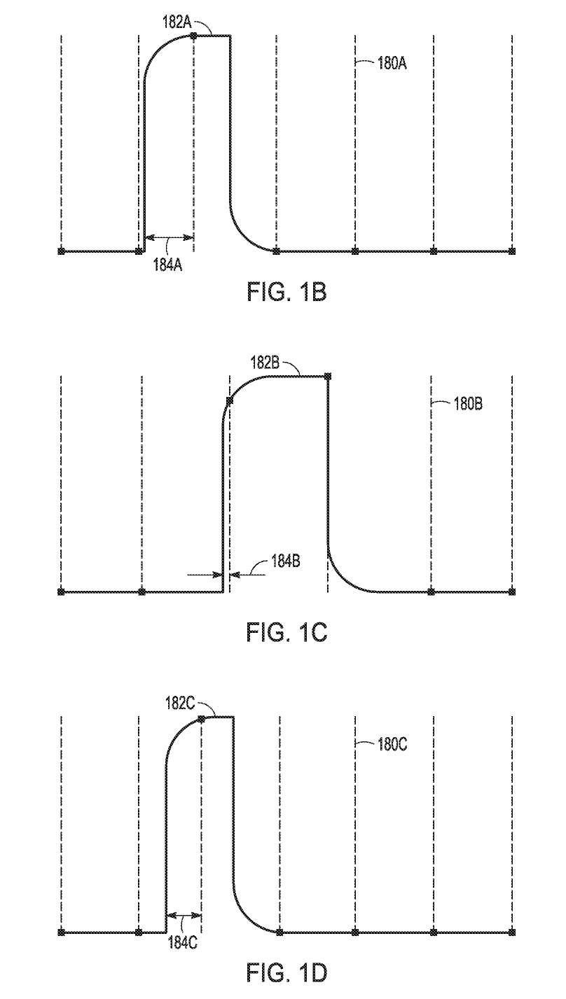

FIG. 1A shows an example of a laser range finding system 100. The laser range finding system 100 can include a transmitter 105, a receiver 110, and synchronization circuitry 165. The transmitter 105 can include a digital-to-analog converter 115, a low pass filter 120, an amplifier 125, a laser driver 130, a laser 135, and waveform circuitry 170. The receiver 110 can include a photosensitive element 140, a transimpedance amplifier 145, an amplifier 150, a low pass filter 155, an analog-to-digital converter 160, and control circuitry 175. The digital-to-analog converter 115 can include a connection to the low pass filter 120, a connection to the waveform circuitry 170, and a connection to the synchronization circuitry 165. The low pass filter 120 can include a connection to the amplifier 125 and a connection to the digital-to-analog converter 115. The amplifier 125 can include a connection to the laser driver 130 and a connection to the low pass filter 120. The laser driver 130 can include a connection to the laser 135 and a connection to the amplifier 125. The laser 135 can include a connection to the laser driver 130. The photosensitive element 140 can include a connection to the transimpedance amplifier 145. The transimpedance amplifier 145 can include a connection to the photosensitive element 140 and a connection to the amplifier 150. The amplifier 150 can include a connection to the transimpedance amplifier 145 and a connection to the low pass filter 155. The low pass filter 155 can include a connection to the amplifier 150 and a connection to the analog-to-digital converter 160. The analog-to-digital converter 160 can include a connection to the low pass filter 155, a connection to the control circuitry 175, and a connection to the synchronization circuitry 165. During operation, the waveform circuitry 170 can provide a digital pulse to the digital-to-analog converter 115. The digital-to-analog converter 115 can convert the digital pulse to an analog pulse. The analog pulse can he filtered by the low pass filter 120 and amplified by the amplifier 125 before being provided to the laser driver 130. The laser driver 130 can modulate the laser 135 with the filtered and amplified analog pulse, such as to provide a laser pulse having a shape based on the analog pulse. The laser 135 can then transmit the laser pulse towards a target. The laser pulse can then be reflected by the target and received by the photosensitive element 140. The photosensitive element 140 can convert the received laser pulse into an analog electrical pulse. The analog electrical pulse can then be amplified by transimpedance amplifier 145 and amplifier 150, and filtered by the low pass filter 155. The analog-to-digital converter 160 can then convert the amplified and filtered analog electrical pulse into a digital pulse. The synchronization circuitry 165 can synchronize a reference sampling clock of the digital-to-analog converter 115 and the analog-to-digital converter 160. The control circuitry 175 can determine a time stamp of the digital pulse provided by the analog-to-digital converter 160, such as by determining a rising edge of the digital pulse. The time stamp of the digital pulse provided by the analog-to-digital converter 160 can then be used to determine a distance between the laser range finding system 100 and the target. In an example the distance can be determined by the formula d=c*t/2, where c can represent the speed of light, d can represent the distance between the target and the laser range finding system, t can represent a time elapsed between transmitting the laser pulse towards the target with the laser 135 and receiving the reflected laser pulse with the photosensitive element 140. Errors in the time stamp associated with the digital pulse can be introduced, such as due to the finite sampling rate of the analog-to-digital converter 160.

FIG. 1B shows an example of an analog electrical pulse 182a, such as that received by the analog-to-digital converter 160 and a corresponding digital pulse 180a provided at the output of the analog-to-digital converter 160. In the example, an error 184a can represent a time difference between a rising edge of the digital pulse 180a and the analog electrical pulse 182a. In the example, the error can represent an overestimate of the time elapsed between transmitting the laser pulse towards the target with the laser 135 and receiving the reflected laser pulse with the photosensitive element 140. In an example, a time stamp of the digital pulse 180a can be determined based on a portion of the digital pulse 180a. For example, the time stamp of the digital pulse 180a can be determined based on a peak, a rising edge, a falling edge, or any other feature of the digital pulse 180a. In an example, the time stamp of the digital pulse 180a can be determined based on a mathematical operation. For example, the time stamp of the digital pulse 180a can be determined based on a convolution of the digital pulse 180 with a reference pulse. The error 184a can represent an error in the time stamp of the digital pulse.

FIG. 1C shows an example of an analog electrical pulse 182b, such as that received by the analog-to-digital converter 160 and a corresponding digital pulse 180b provided at the output of the analog-to-digital converter 160. In the example, an error 184b can represent a time difference between a rising edge of the digital pulse 180b and the analog electrical pulse 182b. In the example, the error can represent an underestimate of the time elapsed between transmitting the laser pulse towards the target with the laser 135 and receiving the reflected laser pulse with the photosensitive element 140. In an example, a time stamp of the digital pulse 180a can be determined based on a portion of the digital pulse 180a. For example, the time stamp of the digital pulse 180a can be determined based on a peak, a rising edge, a falling edge, or any other feature of the digital pulse 180a. In an example, the time stamp of the digital pulse 180a can be determined based on a mathematical operation. For example, the time stamp of the digital pulse 180a can be determined based on a convolution of the digital pulse 180 with a reference pulse. The error 184a can represent an error in the time stamp of the digital pulse.

FIG. 1D shows an example of an analog electrical pulse 182c, such as that received by the analog-to-digital converter 160 and a corresponding digital pulse 180c provided at the output of the analog-to-digital converter 160. In the example, an error 184c can represent a time difference between a rising edge of the digital pulse 180c and the analog electrical pulse 182c. In the example, the error can represent an overestimate of the time elapsed between transmitting the laser pulse towards the target with the laser 135 and receiving the reflected laser pulse with the photosensitive element 140. In an example, a time stamp of the digital pulse 180a can be determined based on a portion of the digital pulse 180a. For example, the time stamp of the digital pulse 180a can be determined based on a peak, a rising edge, a falling edge, or any other feature of the digital pulse 180a. In an example, the time stamp of the digital pulse 180a can be determined based on a mathematical operation. For example, the time stamp of the digital pulse 180a can be determined based on a convolution of the digital pulse 180 with a reference pulse. The error 184a can represent an error in the time stamp of the digital pulse.

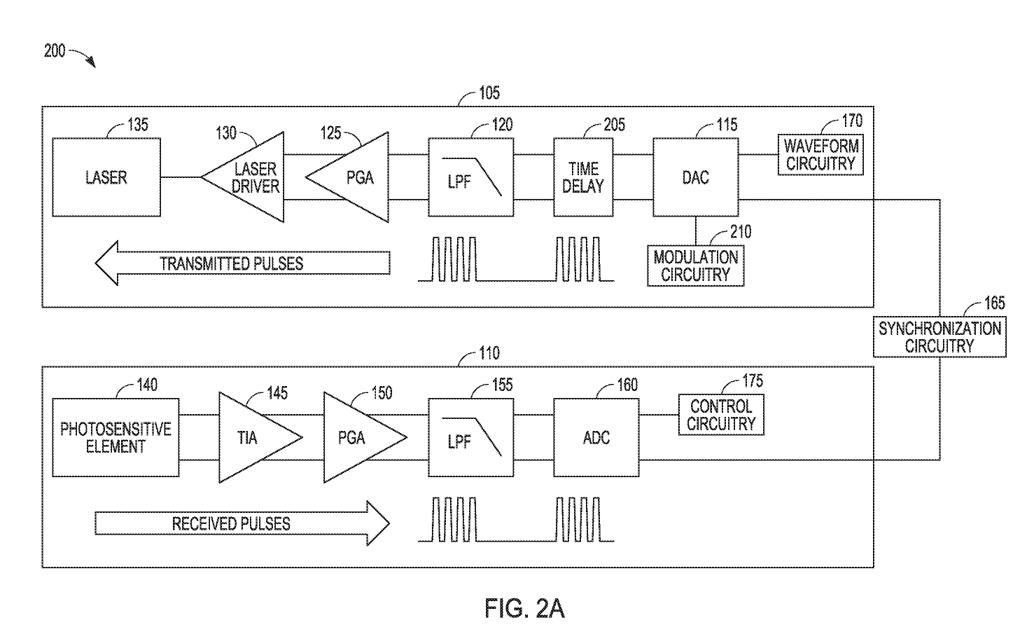

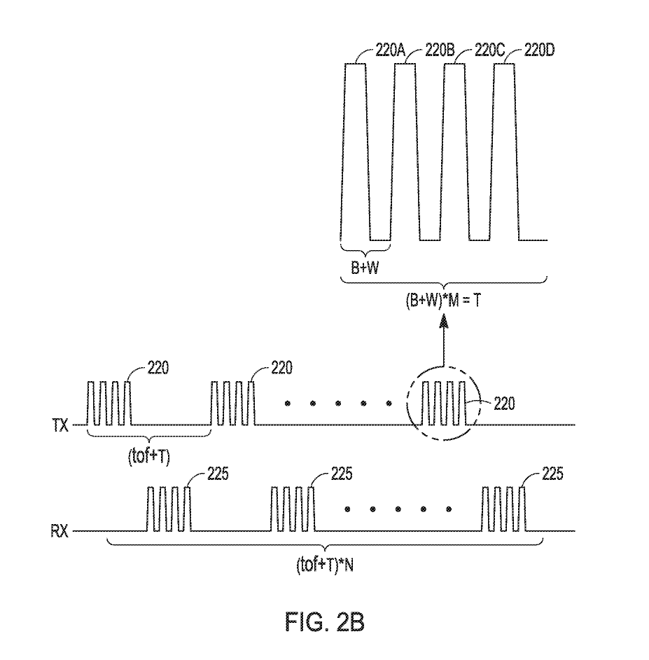

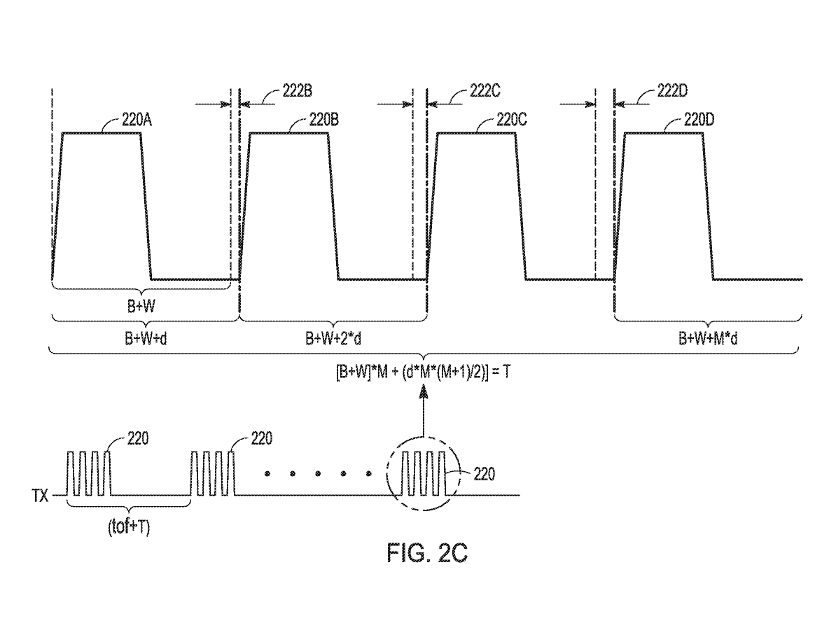

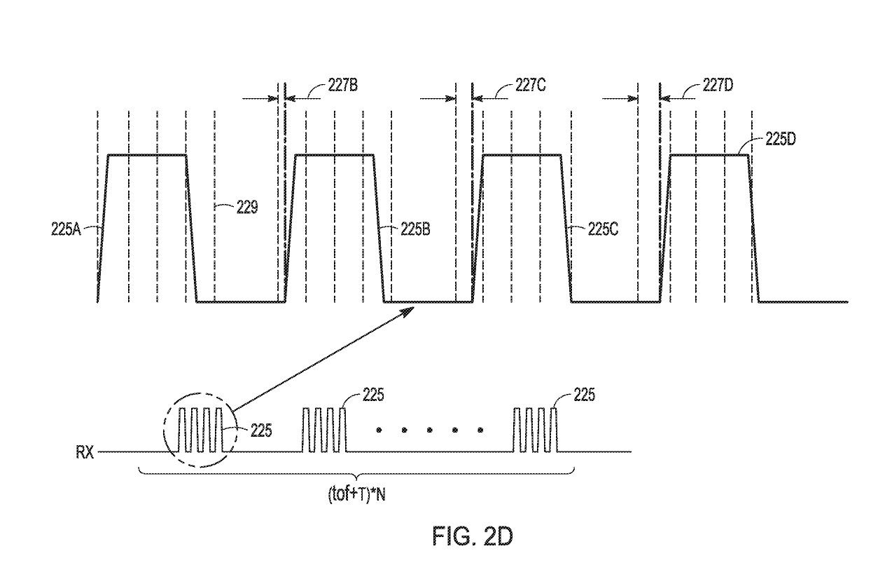

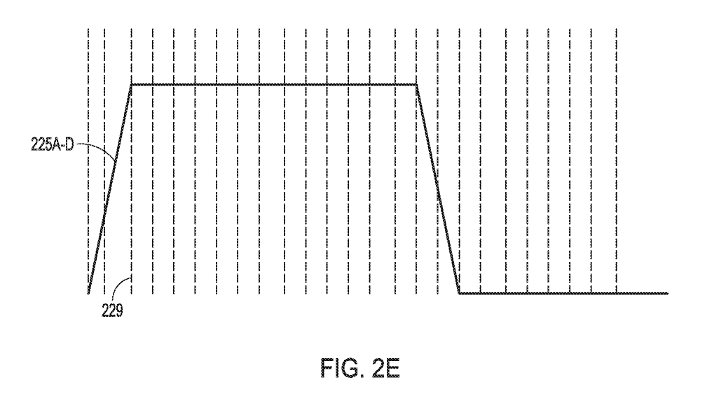

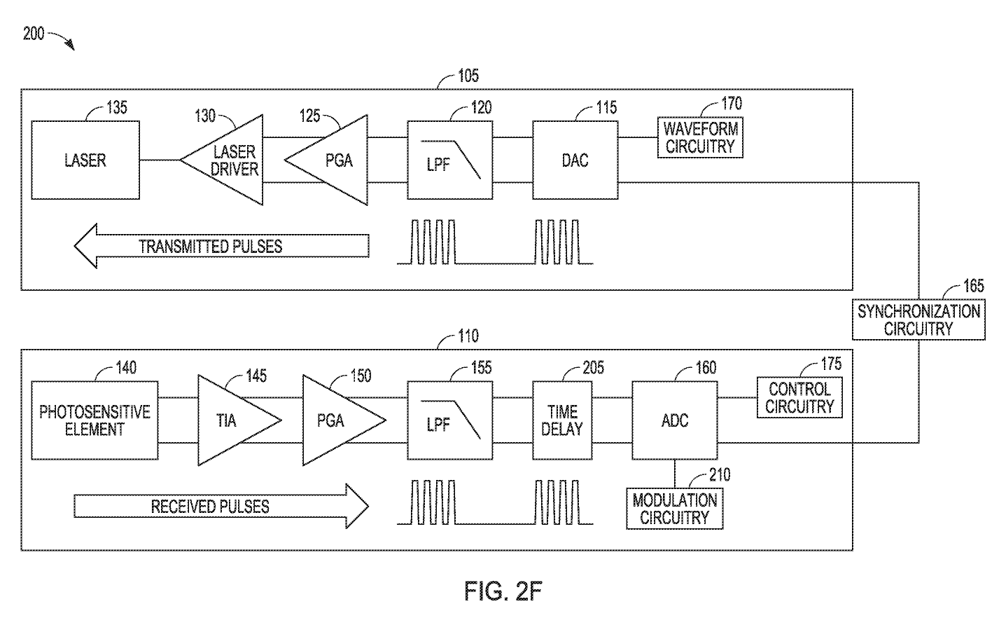

FIG. 2A shows an example of a laser range finding system 200. The laser range finding system 100 can include a transmitter 105, a receiver 110, and synchronization circuitry 165. The transmitter 105 can include a digital-to-analog converter 115, a low pass filter 120, an amplifier 125, a laser driver 130, a laser 135, waveform circuitry 170, time delay circuitry 205, and modulation circuitry 210. The receiver 110 can include a photosensitive element 140, a transimpedance amplifier 145, an amplifier 150, a low pass filter 155, an analog-to-digital converter 160, and control circuitry 175. The digital-to-analog converter 115 can include a connection to the low pass filter 120, a connection to the waveform circuitry 170, a connection to the modulation circuitry 210, and a connection to the synchronization circuitry 165. The low pass filter 120 can include a connection to the amplifier 125 and a connection to the digital-to-analog converter 115. The amplifier 125 can include a connection to the laser driver 130 and a connection to the low pass filter 120. The laser driver 130 can include a connection to the laser 135 and a connection to the amplifier 125. The laser 135 can include a connection to the laser driver 130. The photosensitive element 140 can include a connection to the transimpedance amplifier 145. The transimpedance amplifier 145 can include a connection to the photosensitive element 140 and a connection to the amplifier 150. The amplifier 150 can include a connection to the transimpedance amplifier 145 and a connection to the low pass filter 155. The low pass filter 155 can include a connection to the amplifier 150 and a connection to the analog-to-digital converter 160. The analog-to-digital converter 160 can include a connection to the low pass filter 155, a connection to the control circuitry 175, and a connection to the synchronization circuitry 165. During operation, the waveform circuitry 170 can provide a sequence of digital electrical pulses to the digital-to-analog converter 115. The modulation circuitry 210 can introduce a varying time delay between the pulses in the sequence of pulses. In an example, the modulation circuitry 210 can modulate a pulse width to introduce a varying time delay between the pulses within the sequence of pulses. The digital-to-analog converter 115 can convert the sequence of digital electrical pulses to a sequence of analog pulses. In an example, the time delay circuitry 205 can introduce a varying time delay between the pulses within the sequence of pulses. The sequence of analog pulses can be filtered by the low pass filter 120 and amplified by the amplifier 125 before being provided to the laser driver 130. The laser driver 130 can modulate the laser 135 with the filtered and amplified sequence of analog pulses, such as to provide a sequence of laser pulses having a shape similar to the sequence of analog pulses. The laser 135 can then transmit the sequence of laser pulses towards a target. The sequence of laser pulses can then be reflected by the target and received by the photosensitive element 140. The photosensitive element 140 can convert the received sequence of laser pulses into a sequence of analog electrical pulses. The sequence of analog electrical pulses can then be amplified by transimpedance amplifier 145 and amplifier 150, and filtered by the low pass filter 155. The analog-to-digital converter 160 can then convert the amplified and filtered sequence of analog electrical pulses into a sequence of digital pulses. The synchronization circuitry 165 can synchronize a reference sampling clock of the digital-to-analog converter 115 and the analog-to-digital converter 160. Based on the received sequence of digital pulses, the control circuitry 175 can determine a time elapsed between transmitting a laser pulse towards the target with the laser 135 and receiving the reflected laser pulse with the photosensitive element 140, such as by determining a time stamp associated with the received sequence of digital pulses. In an example, the varying time delay between the pulses in the sequence of pulses can be adjusted, such as to provide at least one pulse in the received sequence of digital pulses that can cause a change in the temporal location of a rising or falling edge of a digital pulse in the received sequence of digital pulses. In an example, the photosensitive element can include a high gain element, such as an avalanche photodiode, such as to provide a saturated pulse to the analog-to-digital converter 160. In an example where the analog-to-digital converter 160 can receive a saturated pulse, the analog-to-digital converter 160 can include a comparator or a one bit analog-to-digital converter.

FIG. 2B shows an example of a sequence of analog electrical pulses, such as that provided to the digital-to-analog converter 115. The sequence of analog electrical pulses can include periodic bursts of pulses 220. In the example, each periodic burst 220 can include pulses 220a, 220b, 220c, and 220d. in the example, B can represent the time between each of the pulses, W can represent the width of the pulses, M can represent the number of pulses, TOF can represent the maximum range of a laser range finding system, such as laser range finding system 200, and N can represent the number of points to be scanned in a field of view of the laser range finding system and the sequence of analog pulses can include a burst for each point in the field of view. A scan time of the system can be represented by the expression N*(TOF+T) and a total transit time can be represented by the expression (B+W)*M.

FIG. 2C shows an example of a sequence of delayed periodic analog electrical pulses, such as that provided to the low pass filter 120. The sequence of delayed periodic analog electrical pulses can include periodic bursts of pulses 220, such as those illustrated in FIG. 2B. The sequence of analog electrical pulses can be adjusted, such as by providing a varying time delay between each of the pulses in the periodic bursts. In an example, the modulation circuitry 210 can provide the varying time delay between each of the pulses in the periodic bursts, such as by modulating a reference sampling clock of the digital-to-analog converter 115. In an example, the time delay circuitry 205 can provide the varying time delay between each of the pulses in the periodic bursts, such as by introducing a time delay after the digital-to-analog converter 115. In an example, the varying time delay can be introduced in a receiver, such as the receiver 110 as shown in FIG. 2F. A duration of each burst of pulses 220 can be selected such that the target can remain approximately stationary during each burst of pulses 220, such that additional delays due to movement of the target can be minimized. In the example shown in FIG. 2C, a time delay between the first and second pulses 220a and 220b can be B+W+d. A time delay between the second and third pulses 220b and 220c can be B+W+2d. A time delay between the third and fourth pulses 220c and 220d can be B+W+3d. A time delay between an m^{th} pulse and an (m−1)^{th} pulse can be B+W+(m−1)*d. The laser driver 130 can modulate the laser 135 with the sequence of adjusted pulses, such as to provide a sequence of laser pulses having a shape similar to the sequence of adjusted pulses. The sequence of laser pulses can then be reflected by the target and received by the photosensitive element 140. The photosensitive element 140 can convert the received sequence of laser pulses into a sequence of analog electrical pulses. The sequence of analog electrical pulses can then be amplified by the transimpedance amplifier 145 and the amplifier 150, and filtered by the low pass filter 155 before being provided to the analog-to-digital converter 160. The analog-to-digital converter can convert the received sequence of analog electrical pulses into a digital output. The digital output can be provided to control circuitry, such as control circuitry 175. The control circuitry can determine a distance between the laser range finding system 200 and the target based on the digital output, such as by determining at least one time stamp in the digital output. The at least one time stamp in the digital output can be compared with a time stamp of the sequence of adjusted pulses, such as to determine a distance between the laser range finding system 200 and the target. The distance can be computed according to the formula d=c*t/2 as described above.

FIG. 2D shows an example of the received sequence of analog electrical pulses being converted into a digital signal, such as by the analog-to-digital converter 160. The received sequence of analog electrical pulses 225a-225d can be sampled by a reference sampling clock of the analog-to-digital converter 160 and converted to digital values at each sampling time 229 of the reference sampling clock. In the example, a temporal position of each of the received sequence of analog electrical pulses 225a-225d, relative to the reference sampling clock of the analog-to-digital converter can be different, such as due to a varying time delay between each of the pulses 225a-225d. The varying time delay between each of the pulses 225a-225d can be illustrated by the time delays 227b-227d. The control circuitry 175 can then overlay each of the converted pulses 225a-225d after being digitized by the analog-to-digital converter 160. FIG. 2E shows an example of the overlaying of digitized pulses, such as the digitized versions of the pulses 225a-225d. Overlaying of the digitized pulses 225a-d can provide an effective sampling rate of the combined analog-to-digital converter 160 and the control circuitry 175 that can be larger than a sampling rate of the analog-to-digital converter 160 alone. In an example where the number of pulses in each of the bursts is M, the effective sampling rate of the combined analog-to-digital converter 160 and the control circuitry 175 can be M times larger than a sampling rate of the analog-to-digital converter 160 alone. In an example where the analog-to-digital converter can have a sampling rate of 250 MSPS and the number of pulses in each burst can be 4, an effective sampling rate of the combined analog-to-digital converter 160 and the control circuitry 175 can be 250 MSPS*4=1 GSPS, such as to provide an accuracy equivalent to a system having an analog-to-digital converter with a sampling rate of 1 GSPS. The movement of the target can be small compared to the resolution of a laser range finding system, such as laser range finding system 200. In an example, the target can include a car travelling at a speed of approximately 150 km/hr (41.6 m/s), the number of pulses M in a burst can be equal to 4, the time between pulses B in a burst can be 200 ns, the width of each of the pulses in a burst can be 20 ns, and an incremental delay d between the pulses can be 1 ns, a movement of the car during a burst of pulses can be approximately 37 μm, which can correspond to a timing error of approximately 1 ps. The timing error of approximately 1 ps can be small compared to a timing resolution of the laser range finding system 200, such as can be determined by an effective sampling rate of the digital output. In an example, the sampling rate of the analog-to-digital converter 160 can be approximately 250 MSPS, which can correspond to an error in the digital output of 4 ns, which can be much smaller than a timing error of approximately 1 ps, such as can be associated with a movement of the target. In an example, the modulation circuitry 210 and the time delay circuitry 205 can be located in the receiver 110 as shown in FIG. 2F.

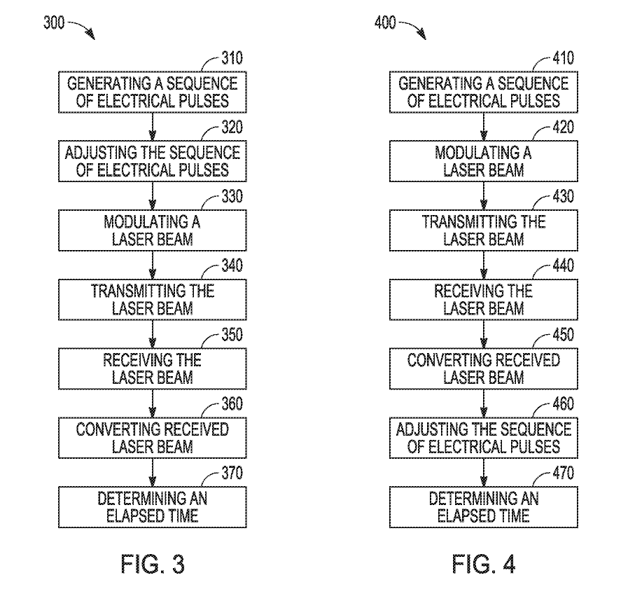

FIG. 3 illustrates an example of a method of operating a laser range finding system, such as laser range finding system 200, such as to determine a target distance. Waveform circuitry, such as waveform circuitry 170 can generate a sequence of electrical pulses. Modulation circuitry, such as modulation circuitry 210 can adjust the sequence of electrical pulses, such as to introduce a varying time delay between the pulses, such as by modulating a reference sampling clock of a digital-to-analog converter, such as digital-to-analog converter 115. In an example, time delay circuitry, such as time delay circuitry 205 can adjust the sequence of electrical pulses, such as to introduce a varying time delay between the pulses. In an example, the generated sequence of electrical pulses can include period bursts of electrical pulses and a varying time delay can be introduced between the electrical pulses within the periodic bursts. A laser driver, such as laser driver 130 can modulate a laser beam with the adjusted sequence of electrical pulses, such as to form a modulated laser beam. A laser, such as laser 135 can transmit the modulated laser beam towards a target. A photosensitive element, such as photosensitive element 140 can receive at least a portion of the transmitted laser beam and can convert the received laser beam into a received electrical signal. Control circuitry, such as control circuitry 175 can determine a time elapsed between transmitting the modulated laser beam towards the target and receiving at least a portion of the transmitted laser beam based at least in part on the varying time delay between the pulses in the generated sequence of electrical pulses. In an example, a time elapsed can be determined based at least in part on an alignment of an electrical pulse in the received sequence of electrical pulses with a reference sampling clock.

FIG. 4 illustrates an example of a method of operating a laser range finding system, such as laser range finding system 200, such as to determine a target distance. Waveform circuitry, such as waveform circuitry 170 can generate a sequence of electrical pulses. A laser driver, such as laser driver 130 can modulate a laser beam with the sequence of electrical pulses, such as to form a modulated laser beam. A laser, such as laser 135 can transmit the modulated laser beam towards a target. A photosensitive element, such as photosensitive element 140 can receive at least a portion of the transmitted laser beam and can convert the received laser beam into a received sequence of electrical pulses. Modulation circuitry, such as modulation circuitry 210 can adjust the sequence of received electrical pulses, such as to introduce a varying time delay between the pulses. In an example, time delay circuitry, such as time delay circuitry 205 can adjust the received sequence of electrical pulses, such as to introduce a varying time delay between the pulses. Control circuitry, such as control circuitry 175 can determine a time elapsed between transmitting the modulated laser beam towards the target and receiving at least a portion of the transmitted laser beam based at least in part on the varying time delay between the pulses in the received sequence of electrical pulses.

1. A method for determining a target distance in a laser range finding system, the method comprising:
generating a sequence of electrical pulses;
adjusting the generated sequence of electrical pulses to introduce a varying time delay between the pulses in the generated sequence of electrical pulses;
modulating a laser beam with the adjusted sequence of electrical pulses to forma modulated laser beam;
transmitting the modulated laser beam towards a target;
receiving at least a portion of the transmitted laser beam;
converting the received portion of the transmitted laser beam into a received sequence of electrical pulses; and
determining a time elapsed between transmitting the modulated laser beam towards the target and receiving at least a portion of the transmitted laser beam, the elapsed time being determined based at least in part on the varying time delay between the pulses in the generated sequence of electrical pulses.

2. The method of claim 1, wherein the generated sequence of electrical pulses includes periodic bursts of electrical pulses, and adjusting the generated sequence of electrical pulses includes introducing a varying time delay between electrical pulses within the periodic bursts.

3. The method of claim 2, comprising determining a time elapsed between transmitting the modulated laser beam towards the target and receiving at least a portion of the transmitted laser beam based on an alignment of an electrical pulse in the received electrical sequence of pulses with a reference sampling clock.

4. The method of claim 2 wherein adjusting the generated sequence of electrical pulses includes modulating a time delay circuit to introduce a varying time delay between electrical pulses within the periodic bursts.

5. The method of claim 2 wherein adjusting the generated sequence of electrical pulses includes modulating a reference sampling clock of a digital-to-analog converter to introduce a varying time delay between electrical pulses within the periodic bursts.

6. The method of claim 2 wherein adjusting the generated sequence of electrical pulses includes modulating a pulse width of electrical pulses within the periodic bursts to provide a varying time delay.

7. A method for determining a target distance in a laser range finding system, the method comprising:
generating a sequence of electrical pulses;
modulating a laser beam with the generated sequence of electrical pulses to forma modulated laser beam;
transmitting the modulated laser beam towards a target;
receiving at least a portion of the transmitted laser beam;
converting the received portion of the transmitted laser beam into a received sequence of electrical pulses;
adjusting the received sequence of electrical pulses to introduce a varying time delay between pulses in the received sequence of electrical pulses;
determining a time elapsed between transmitting the modulated laser beam towards the target and receiving at least a portion of the transmitted laser beam, the elapsed time being determined based at least in part on the varying time delay between the pulses in the received sequence of electrical pulses.

8. The method of claim 7, wherein the received sequence of electrical pulses includes periodic bursts of electrical pulses, and adjusting the received sequence of electrical pulses includes introducing a varying time delay between electrical pulses within the periodic bursts.

9. The method of claim 8, comprising determining a time elapsed between transmitting the modulated laser beam towards the target and receiving at least a portion of the transmitted laser beam based on alignment of an electrical pulse in the received sequence of electrical pulses with a reference sampling clock.

10. The method of claim 8 wherein adjusting the received sequence of electrical pulses includes modulating a time delay circuit to introduce a varying time delay between electrical pulses within the periodic bursts.

11. The method of claim 8 wherein adjusting the received sequence of electrical pulses includes modulating a reference sampling clock of an analog-to-digital converter to introduce a varying time delay between electrical pulses within the periodic bursts.

12. A laser range finding system for determining a target distance, the system comprising:
a digital-to-analog converter configured to generate a sequence of electrical pulses;
modulation circuitry configured to provide a varying time delay between the pulses in the generated sequence of pulses;
a laser driver configured to modulate a laser beam with the modulated sequence of electrical pulses to form a modulated laser beam;
a laser configured to transmit the modulated laser beam towards a target;
a photosensitive element configured to receive at least a portion of the transmitted laser beam;
an amplifier configured to convert the received portion of the transmitted laser beam into a received electrical signal;
processing circuitry configured to determine a time elapsed between transmitting the modulated laser beam towards the target and receiving at least a portion of the transmitted laser beam, the elapsed time being determined based at least in part on the varying time delay between the pulses in the generated sequence of electrical pulses.

13. The system of claim 12, wherein the sequence of electrical pulses includes periodic bursts of electrical pulses, and providing a varying time delay includes introducing a varying time delay between electrical pulses within the periodic bursts.

14. The system of claim 13, wherein the processing circuitry is further configured to determine a time elapsed between transmitting the modulated laser beam towards the target and receiving at least a portion of the transmitted laser beam based on alignment of an electrical pulse in the received electrical signal with a reference sampling clock.

15. The system of claim 13 comprising a time delay circuit configured to modulate the sequence of electrical pulses to introduce a varying time delay between the pulses in the generated sequence of electrical pulses.

16. The system of claim 13 comprising a clock modulation circuit configured to modulate a reference sampling clock of the digital-to-analog converter to introduce a varying time delay between the pulses in the generated sequence of electrical pulses.

17. The system of claim 13 further comprising an analog-to-digital converter configured to sample and digitize the received electrical signal, wherein the analog-to-digital converter has a lower sampling rate than the digital-to-analog converter.

18. The system of claim 17 wherein the varying time delay between electrical pulses within the periodic bursts is less than or equal to a period of a reference sampling clock of the analog-to-digital converter.

19. The system of claim 17 wherein the processing circuitry is further configured to overlap each electrical pulse within a periodic burst to provide an effective sampling rate that is larger than the sampling rate of the analog-to-digital converter.

20. A laser range finding system for determining a target distance, the system comprising:
a digital-to-analog converter configured to generate a sequence of electrical pulses;
a laser driver configured to modulate a laser beam with the modulated sequence of electrical pulses to form a modulated laser beam;
a laser configured to transmit the modulated laser beam towards a target;
a photosensitive element configured to receive at least a portion of the transmitted laser beam;
an amplifier configured to convert the received portion of the transmitted laser beam into a received sequence of electrical pulses;
modulation circuitry configured to provide a varying time delay between the pulses in the received sequence of electrical pulses;
processing circuitry configured to determine a time elapsed between transmitting the modulated laser beam towards the target and receiving at least a portion of the transmitted laser beam, the elapsed time being determined based at least in part on the varying time delay between the pulses in the received sequence of electrical pulses.
